(19) United States
(12) Patent Application Publication
(10) Pub. No.: US 2014/0032755 A1
(43) Pub. Date: Jan. 30, 2014

(54) METHOD FOR PROVIDING CLOUD COMPUTING SERVICE AND A CLOUD COMPUTING SERVICE MANAGEMENT SYSTEM

(71) Applicant: Tsung-Yu HUANG, Taipei City (TW)

(72) Inventor: Tsung-Yu HUANG, Taipei City (TW)

(21) Appl. No.: 13/558,918

(22) Filed: Jul. 26, 2012

(51) Int. Cl. G06F 15/173

(52) U.S. Cl. 709/225

(57) ABSTRACT

A method for providing cloud computing service and a cloud computing service management system are proposed as a solution for achieving a PC-free computing environment that allows global computing users to perform information processing tasks without having to use personal computers (PC), and which is characterized by the use of modem units for the realization and implementation of a PC-free computing environment, wherein the modem units are connected via a communication system to a central host computer where a set of cloud computing resources are provided, so that any end user can gain access to and use the cloud computing resources on the central host computer simply by connecting a terminal device to the modem unit.

### BACKGROUND OF THE INVENTION

1. Field of the Invention

The present invention relates to information technology, and more particularly to a method for providing cloud computing service and a cloud computing service management system, which can be used to offer a PC-free computing environment that allows global computing users to perform information processing tasks without having to use personal computers (PC).

2. Description of Related Art

Personal computers (PC) are nowadays an indispensable tool for all people at offices and homes to perform information processing tasks for work and entertainment. PC-based information processing tasks typically include, for example, word processing, spreadsheet, database, graphic drawing, photo processing, email, Web browsing, or any special applications in the field of science and technology or business management. Personal computers include many various different types, such as desktop types and portable types including notebook computers, tablet computers, PDA (personal digital assistant) computers, to name a few.

Due to the extremely large quantities of PC units that are demanded in today's business world, there are many cases that one single user owns a number of PC units for various purposes, for example, one desktop computer at home for entertainment, another desktop computer in office for business, and one notebook or tablet computer on road or business travel. Moreover, large business entities or organizations, such as factories, hotels, restaurants, schools, and libraries, are typically installed with large quantities of PC units for their employers or customers to use. One problem to the excessively large demands in PC, however, is that it undesirably and seriously causes more resource consumption and industrial pollutions due to the manufacture of PC.

In addition, another problem in the use of PC for information processing is that it requires software developers to distribute software programs by means of optical discs such as CD or DVD, which also causes excessive consumption of material resources in the manufacture of optical discs, and moreover causes the software programs to be easily illegally copied and thus infringed on copyright.

In view of the aforementioned problems of PC-based information processing, there exists an urgent need and research topic in the information industry for a solution that can achieve a PC-free computing environment so that it can help reduce excessive resource consumption and industrial pollutions as well as help prevent illegal copying of software programs for protection of the copyright of software.

### SUMMARY OF THE INVENTION

It is the first aspect of the present invention to provide a method for providing cloud computing service and a cloud computing service management system as a solution for achieving a PC-free computing environment, which allows computing users, including users at home, offices, and organizations, to perform information processing tasks that have been traditionally PC-based without having to purchase a PC unit.

It is another aspect of the present invention to provide a solution for achieving a PC-free computing environment that can help reduce excessive resource consumption and industrial pollutions caused by the manufacture of PC.

It is still another aspect of the present invention to provide a solution for achieving a PC-free computing environment that allows software developers to distribute software programs without having to use optical discs as CD or DVD, so as to help prevent illegal copying of software programs for protection of the copyright of software.

The method for providing cloud computing service according to the present invention comprises: (1) installing at least one modem unit at a specific work site where computing power is needed; (2) linking the modem unit via a communication system to a central host computer or processor; (3) installing a set of cloud computing resources on the central host computer; and (4) in the event that an end user wants to use the cloud computing resources on the central host computer, instructing the end user to connect a terminal device to the modem unit at the work site, so that the terminal device can be linked via the modem unit and the communication system to the central host computer, thus allowing the end user to gain access to and use the cloud computing resources on the central computer via the terminal device.

The cloud computing service management system according to the present invention comprises: (a) at least one modem unit equipped at a specific work site where computing power is needed, which allows the terminal device to be linked thereto; and (b) a main control unit, which is installed at a service station and links the modem unit via the communication system to the central host computer, and which, in the event that an end user wants to use the cloud computing resources on the central host computer by connecting a terminal device to the modem unit, is capable of linking the terminal device connected to the terminal device via the communication system to the central host computer, thereby allowing the end user to gain access to and use the cloud computing resources on the central computer via the terminal device.

The present invention is characterized by the use of modem units for the realization and implementation of a PC-free computing environment, wherein the modem units are connected via a communication system to a central host computer where a set of cloud computing resources are provided, so that any end user can gain access to and use the cloud computing resources on the central host computer simply by connecting a non-PC terminal device to the modem unit.

One advantage of the present invention is that it can be used to provide a PC-free computing environment that allows a computing user in any fields to use computing powers without having to purchase a PC unit, application software programs, and storage devices such as hard disks, all of which are available from the cloud computing resources on the central host computer. Therefore, computing users no longer need to use PC and the computer industry no longer needs to manufacture PC as well as all PC-related hardware devices and storage medium such as CD or DVD for distribution of software programs. This benefit can help reduce unnecessary resource consumption and industrial pollutions that have been seriously caused by excessive PC manufacture in the industry.

Another advantage of the present invention is that it allows software developers to distribute software programs by placing them on the central host computer as part of the cloud computing resources without having to distribute and sell software programs via optical discs such as CD or DVD. This benefit can help prevent the software programs from illegally copied and thus allow the copyright of the software programs to be duly protected.

### BRIEF DESCRIPTION OF THE DRAWINGS

The present invention will be more fully understood by reading the following detailed description of the preferred embodiments, with reference made to the accompanying drawings, wherein:

FIG. 1 is a schematic diagram showing the overall application of the present invention;

FIG. 2 is a schematic diagram showing a number of various different types of a communication system used in conjunction with the cloud computing service management system of the present invention;

FIG. 3 is a schematic diagram showing how the cloud computing service management system of the invention can be used to provide a PC-free computing environment;

FIG. 4 is a schematic diagram showing the system architecture of the cloud computing service management system of the present invention; and

FIG. 5 is an activity diagram showing a process of user-machine interaction between an end user and the cloud computing service management system of the invention during actual operation.

### DETAILED DESCRIPTION OF THE INVENTION

The present invention provides a method for providing cloud computing service and a cloud computing service management system as a solution for achieving a PC-free computing environment, which is disclosed in full details by way of preferred embodiments in the following with reference to the accompanying drawings.

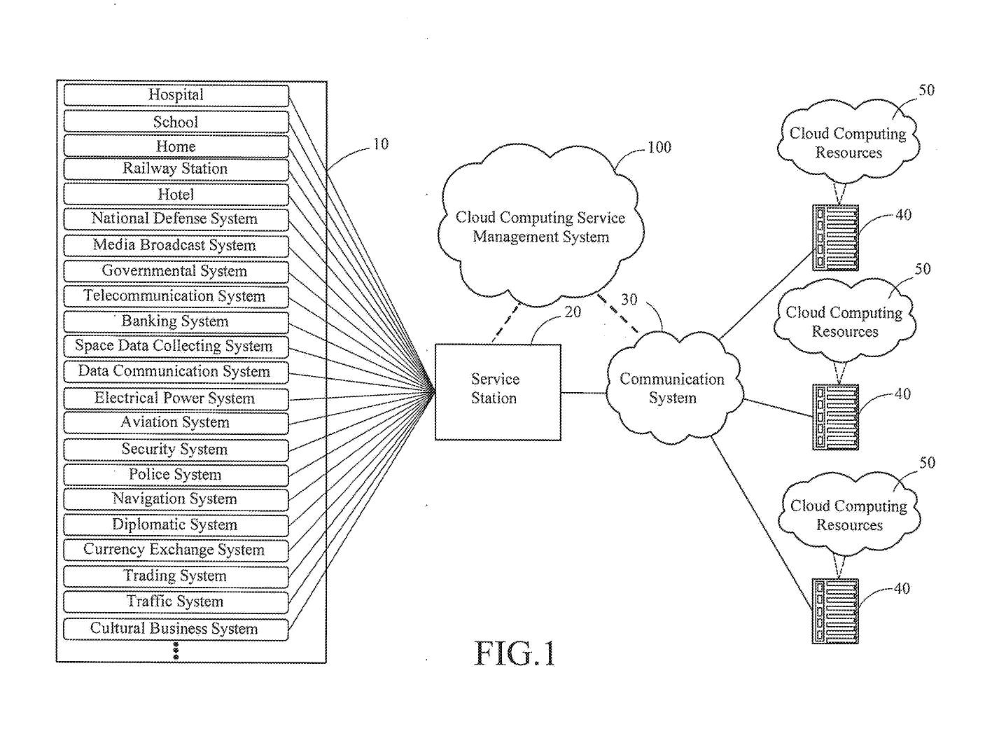

FIG. 1 is a schematic diagram showing the application of the present invention when realized as a cloud computing service management system (as the object indicated by the reference numeral 100). As shown, the cloud computing service management system 100 is designed with the main purpose of providing a PC-free computing environment, so that a work site 10 where computing power is required, such as hospital, school, individual user, railway station, hotel, national defense system, media broadcast system, governmental system, telecommunication system, banking system, space data collecting system, data communication system, electrical power system, aviation system, security system, police system, navigation system, diplomatic system, currency exchange system, trading system, traffic system, cultural business system, to name just a few, can be equipped with computing power without having to purchase and install a large number of PC units as desktop or notebook computers. In other words, the cloud computing service management system 100 allows computing users to use all traditional PC-based applications, such as word processor, spreadsheet, database, drawing tool, photo processing, TV-mail, Web browsing, or any special applications in the field of science and technology or business management without having to purchase a PC unit.

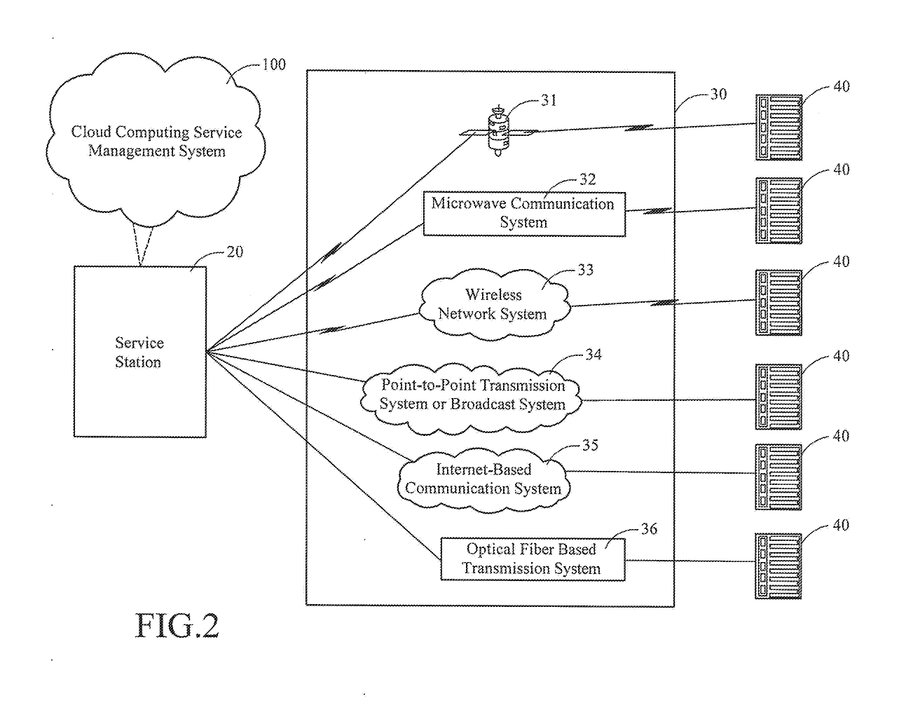

In practice, the cloud computing service management system 100 is installed at a service station 20 which is linked via an existing communication system 30 to one or more computer rooms, each being installed with at least one central host computer or processor 40 on which a set of cloud computing resources 50 are installed. As shown in FIG. 2, the communication system 30 is a digital data transmission system which can be, for example, a satellite-based communication system 31, a ground-based microwave communication system 32, a wireless network system 33, a point-to-point transmission system or broadcast system 34, an Internet-based communication system 35, or an optical fiber based transmission system 36, to name a few.

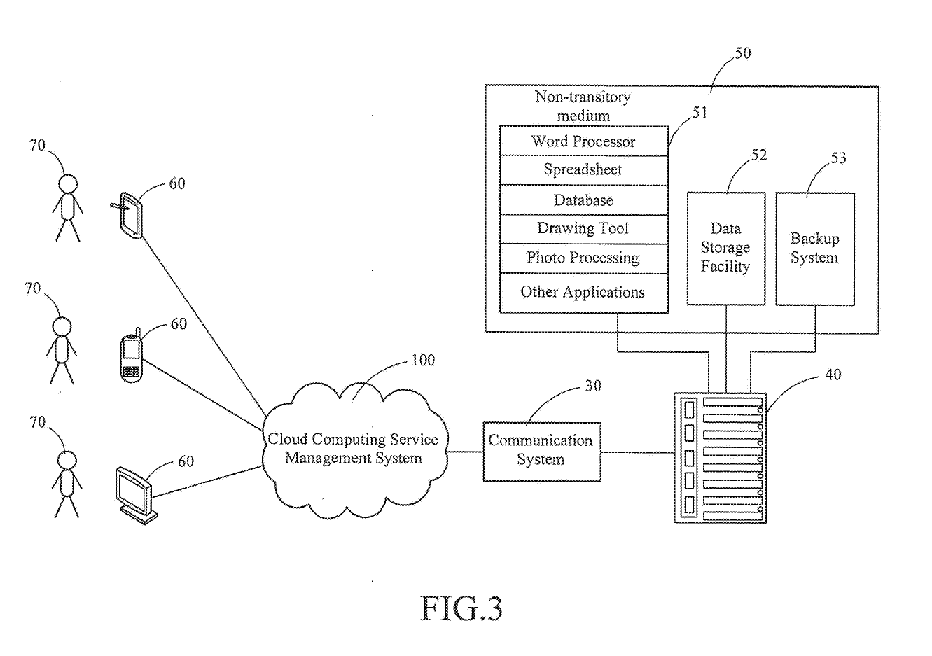

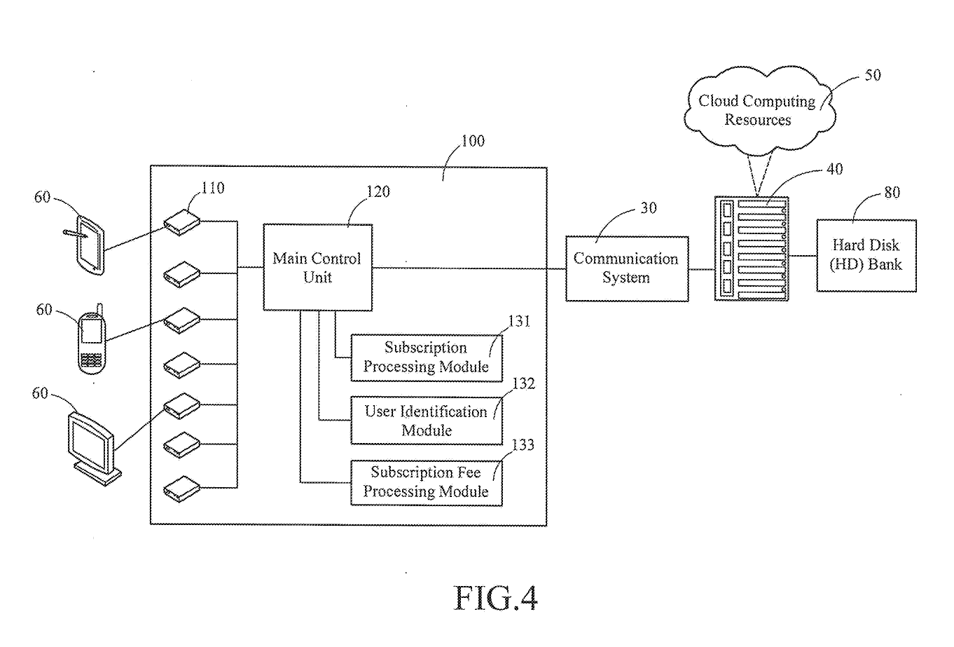

As shown in FIG. 3, the cloud computing resources 50 on the central host computer or processor 40 include a suite of application software programs 51 implemented on a memory, such as a non-transitory computer-readable storage medium, a data storage facility 52, and a backup system 53. The suite of application software programs 51 include, for example, word processor, spreadsheet, database, drawing tool, photo processing, or any applications that were traditionally PC-based. In operation, the cloud computing service management system of the invention 100 allows an end user 70 to use a terminal device 60, such as an intelligent mobile phone, a dummy tablet screen display unit, or any electronic device equipped with data input and output capabilities, for linking to the central host computer 40 to gain access to and use the cloud computing resources 50 on the central host computer 40. For example, the end user 70 can gain access to the suite of application software programs 51 so as to use a word processor to write a document, or use a drawing tool to create a graphic, and then use the data storage facility 52 for permanent storage of the finished documents. Moreover, in case of need, the backup system 53 can be used for backup of the data stored on the data storage facility 52. In practice, for example, the data storage facility 52 can be implemented with a hard-disk (HD) bank 80, as shown in FIG. 4.

The present invention is characterized in that it allows the terminal device 60 to be a dummy device having only data input and output capabilities without having to be equipped with a central processing unit (CPU), memory, hard disks, CD/DVD drives, operating system, and various application software programs as the traditional PC units such as desktop computers, notebook computers, tablet computers, PDA (personal digital assistant) computers, and so on. In practice, the terminal device 60 can be, for example, an intelligent mobile phone or a dummy tablet screen display unit with data input and output functionality only. In other words, the invention can be used to provide a PC-free computing environment that allows the use of computing power without requiring the end user 70 to purchase a PC unit.

As shown in FIG. 4, in architecture, the cloud computing service management system 100 comprises: (A) at least one modem unit 110; and (B) a main control unit 120, which can optionally include: (B1) a subscription processing module 131; (B2) a user identification module 132; and (B3) a subscription fee processing module 133. Firstly, the respective attributes and functions of these system components are described in details in the following.

The modem unit 110 is a data transmitting/receiving device based on modulation and demodulation of digital data for transmission over the communication system 30, and which can be any traditional or modern type that is capable of transmitting digital data over the communication system 30 in compliance with any existing data communication standards or types, such as ITU (International Telecommunication Union) compliant modem, ADSL (Asymmetric Digital Subscriber Line) compliant modem, shared coaxial cable modem, wireless modem, a hybrid modem that combines any two or more of the foregoing technologies, or various other types. In practice, the modem unit 110 is installed at a specific work site 10 where computing power is required, such as hospital, school, home, railway station, hotel, national defense system, media broadcast system, governmental system, telecommunication system, banking system, space data collecting system, data communication system, electrical power system, aviation system, security system, police system, navigation system, diplomatic system, currency exchange system, trading system, traffic system, cultural business system, to name just a few. In operation, the modem unit 110 serves as a data communication link over the communication system 30 between the terminal device 60 and the central host computer 40, which can be either a cable-connected type or a wireless-connected type, and preferably a wireless-connected type based on the Wi-Fi or WiMAX wireless technology. In the case that the work site 10 is intended for a number of end users, the modem unit 110 is installed in large quantity so that multiple end users at the work site 10 can be linked and gain access to the central host computer 40 at the same time. In practice, the modem unit 110 allows each end user 70 to connect his/her terminal device 60 thereto, so that the terminal device 60 can be linked via the cloud computing service management system of the invention 100 and the communication system 30 to the central host computer 40. In other words, the end user 70 needs just to connect the terminal device 60 to the modem unit 110, and if the end user 70 is an authorized user, the cloud computing service management system of the invention 100 will connect the terminal device 60 to the central host computer 40 for the end user 70 to gain access to and use the cloud computing resources 50 on the central host computer 40.

The main control unit 120 is installed at a service station 20, which has one end linked to the modem unit 110, and the other end linked via the communication system 30 to the central host computer 40. In operation, the main control unit 120 is capable of linking the terminal device 60 connected to each modem unit 110 via the communication system 30 to the central host computer 40, so as to allow the terminal device 60 and the central host computer 40 to be mutually linked for data exchange. When the mutual linking is established, it allows the end user 70 to gain access to and use the cloud computing resources 50 on the central host computer 40, such as using the computing power of the central host computer 40 to run a computer program, using the suite of application software programs 51, or using the data storage facility 52, which is preferably implemented with a hard-disk (HD) bank 80 shown in FIG. 4, for permanent storage of computer files.

The subscription processing module 131 is capable of providing an online subscription procedure that allows the end user 70 to subscribe for authorized use of the cloud computing resources 50 on the central host computer 40. After the subscription procedure is completed, the subscription processing module 131 will grant the end user 70 an authorization status, a user account, and an allocated operating space for the end user 70 to use the cloud computing resources 50 on the central host computer 40. During this subscription procedure, the end user 70 can choose desired options, such as processing speed, application software programs, and storage capacity. Each option is associated with a different fee. For example, higher fees are charged for a higher processing speed, a larger capacity of storage space in the data storage facility 52, and a larger number of applications selected from the suite of application software programs 51. For example, if the suite of application software programs 51 include a word processor and a spreadsheet, but the end user 70 only needs to use the word processor and don't want to use the spreadsheet, then in this case, the end user 70 can choose to use only the word processor from the suite of application software programs 51 without choosing the spreadsheet. The fee for each application in the suite of application software programs 51 may be different and can be set arbitrarily by the software developers.

The user identification module 132 is capable of identifying whether each terminal device 60 linked to the modem unit 110 belongs to an authorized user. The identification method used by the user identification module 132 can be, for example, checking whether the username and password provided by the end user 70 are valid, inserting an ID chip in the terminal device 60, or any existing technology that can be used for identification of the end user 70. After the user identification module 132 identifies that the terminal device 60 belongs to an authorized user, it will command the main control unit 120 to link the terminal device 60 to the central host computer 40, thereby allowing the end user 70 to gain access to and use the cloud computing resources 50 on the central host computer 40 via the terminal device 60.

The subscription fee processing module 133 is capable of calculating an amount of fee payable by the end user 70 for the use of the cloud computing resources 50 on the central host computer 40 by using the terminal device 60 connected to the modem unit 110. In practice, the fee charging method can be arbitrarily assigned by the service provider and based on monthly, daily, or hourly payment plan.

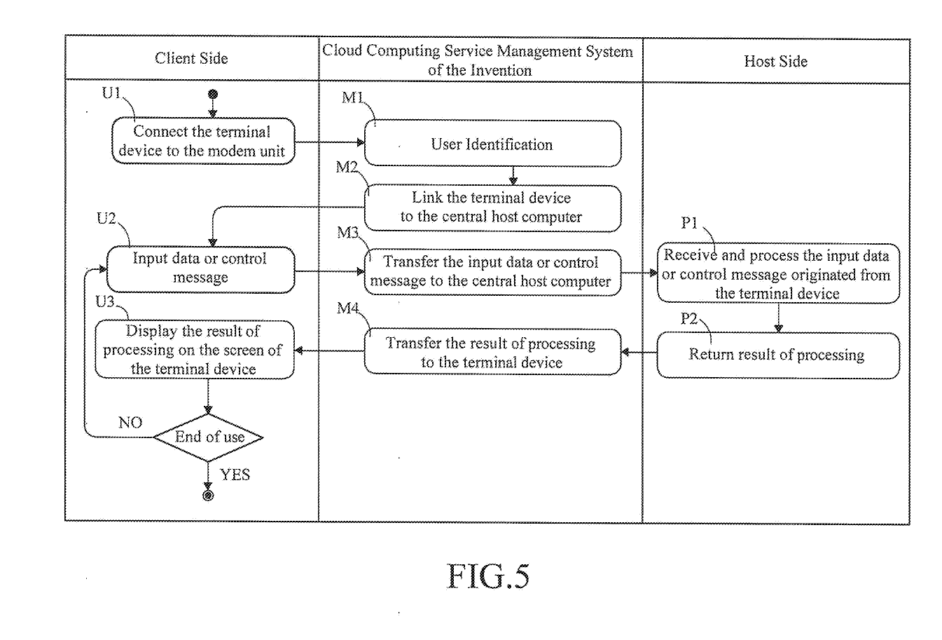

The following is a detailed description of an actual operation of the cloud computing service management system of the invention 100 when an end user 70 wants to use the cloud computing resources 50 on the central host computer 40, which is described in reference to the activity diagram of FIG. 5 wherein a process of user-machine interaction between the end user 70 and the cloud computing service management system of the invention 100 is illustrated. In this case, the end user 70 can be any former PC user, such as a student or teacher in school, an office worker in enterprise or governmental organization, a home-based or mobile person, to name just a few.

Referring to FIG. 5, in the first step, the end user 70 performs a client-side operation U1, wherein the end user 70 connects his/her terminal device 60 to the modem unit 110 at the work site 10. After being successfully connected, it will activate the cloud computing service management system of the invention 100 to command the user identification module 132 to perform a machine operation M1 for identifying the authorization status of the terminal device 60 being connected. If the authorization status is confirmed, the user identification module 132 then commands the main control unit 120 to perform a machine operation M2 for connecting the terminal device 60 to the central host computer 40.

Next, the end user 70 performs a client-side operation U2, wherein the end user 70 can now gain access to and use the cloud computing resources 50 on the central host computer 40 by inputting data or control message to the terminal device 60. This user-initiated operation will then cause the cloud computing service management system of the invention 100 to command the main control unit 120 to perform a machine operation M3, wherein the user-inputted data or control message received via the modem unit 110 from the terminal device 60 is transferred via the communication system 30 to the central host computer 40. On the host side, the central host computer 40 will respond by performing a host-side operation P1, wherein the received data or control message is processed. After this, the central host computer 40 performs a host-side operation P2, wherein the result of processing is downloaded and transmitted via the communication system 30 to the cloud computing service management system 100.

Next, the cloud computing service management system 100 performs a machine operation M4, wherein the main control unit 120 is activated to transfer the downloaded data received from the central host computer 40 via the modem unit 110 to the terminal device 60. On the client side, the terminal device 60 then performs a client-side operation U3, wherein the downloaded data is displayed on the terminal device 60. This completes one round of operation. If the end user 70 wants to perform another operation, the client-side procedure U2 is repeated to carry out another round of interaction between the terminal device 60 and the central host computer 40, until all operations by the end user 70 are completed.

It can be learned from the foregoing description that one advantage of the invention is that it can be used to provide a PC-free computing environment that allows a computing user in any fields to use computing powers without having to purchase a PC unit, application software programs, and storage devices such as hard disks, all of which are available from the cloud computing resources 50 on the central host computer 40. Therefore, computing users no longer need to use PC and the computer industry no longer needs to manufacture PC as well as all PC-related hardware devices and storage medium such as CD or DVD for distribution of software programs. This benefit can help reduce unnecessary resource consumption and industrial pollutions that have been seriously caused by excessive PC manufacture in the industry.

In addition, another advantage of the present invention is that it allows software developers to distribute software programs by placing them on the central host computer 40 as part of the cloud computing resources 50 without having to distribute and sell software programs via optical discs such as CD or DVD. This benefit can help prevent the software programs from illegally copied and thus allow the copyright of the software programs to be duly protected.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for providing cloud computing service in a PC-free computing environment, comprising:
(1) installing at least one modem unit at a specific work site where computing power is needed;
(2) linking the modem unit via a communication system to a central host processor;
(3) installing a set of cloud computing resources on the central host processor; and
(4) in the event that an end user wants to use the cloud computing resources on the central host processor, instructing the end user to connect a terminal device to the modem unit at the work site, so that the terminal device can be linked via the modem unit and the communication system to the central host processor, thus allowing the end user to gain access to and use the cloud computing resources on the central host processor via the terminal device.

2. The method of claim 1, wherein the terminal device is an intelligent mobile phone or a dummy tablet screen display unit.

3. The method of claim 1, wherein the communication system is a satellite communication system, a ground-based microwave transmission system, a wireless network system, a point-to-point telecommunication system, a point-to-point broadcast system, an Internet-based communication system, or an optical fiber based transmission system.

4. The method of claim 1, wherein the cloud computing resources on the central host processor include a suite of application software programs and a data storage facility.

5. The method of claim 1, wherein the modem unit is a cable-connected type.

6. The method of claim 1, wherein the modem unit is a wireless type.

7. The method of claim 6, wherein the wireless type of modem unit is a Wi-Fi or a WiMAX based type.

8. The method of claim 1, further comprising:
providing a subscription plan for the end user, whereby the end user can subscribe for authorized use of the cloud computing resources on the central host computer, and choose a set of options including processing speed, application software programs, and storage capacity.

9. The method of claim 1, further comprising:
providing a user identification procedure for the end user, so as to identifying whether a terminal device linked to the modem unit belongs to an authorized user.

10. The method of claim 1, further comprising:
providing a fee charging plan for the end user, so as to calculate the fee payable by the end user for the use of the cloud computing resources on the central host processor.

11. A cloud computing service management system for providing a PC-free computing environment, which allows a terminal device to be linked via a communication system to a central host computer on which a set of cloud computing resources are installed, so that an end user can gain access to and use the cloud computing resources on the central host computer via the terminal device, and which comprises:
(a) at least one modem unit equipped at a specific work site where computing power is needed, which allows the terminal device to be linked thereto; and
(b) a main control unit, which is installed at a service station and links the modem unit via the communication system to the central host computer, and which, in the event that an end user wants to use the cloud computing resources on the central host computer by connecting a terminal device to the modem unit, is capable of linking the terminal device connected to the terminal device via the communication system to the central host computer, thereby allowing the end user to gain access to and use the cloud computing resources on the central computer via the terminal device.

12. The cloud computing service management system of claim 11, wherein the terminal device is an intelligent mobile phone or a dummy tablet screen display unit.

13. The cloud computing service management system of claim 11, wherein the communication system is a satellite communication system, a ground-based microwave transmission system, a wireless network system, a point-to-point telecommunication system, a point-to-point broadcast system, an Internet-based communication system, or an optical fiber based transmission system.

14. The cloud computing service management system of claim 11, wherein the cloud computing resources on the central host computer include a suite of application software programs and a data storage facility.

15. The cloud computing service management system of claim 14, wherein the data storage facility includes a hard disk bank.

16. The cloud computing service management system of claim 11, wherein the modem unit is a cable-connected type.

17. The cloud computing service management system of claim 11, wherein the modem unit is a wireless type.

18. The cloud computing service management system of claim 17, wherein the wireless type of modem unit is a Wi-Fi or a WiMAX based type.

19. The cloud computing service management system of claim 11, wherein the main control unit includes:
a subscription processing module, which allows the end user to subscribe for authorized use of the cloud computing resources on the central host computer, and to choose a set of options including processing speed, application software programs, and storage capacity.

20. The cloud computing service management system of claim 11, wherein the main control unit includes:
a user identification module, which is capable of identifying whether a terminal device linked to the modem unit belongs to an authorized user.

21. The cloud computing service management system of claim 11, wherein the main control unit includes:
a subscription fee processing module, which is capable of calculating an amount of fee payable by the end user for the use of the cloud computing resources on the central host computer.
